(19) United States
(12) Patent Application Publication
(10) Pub. No.: US 2005/0232233 A1
(43) Pub. Date: Oct. 20, 2005

(54) Configuration of a broadband cable network-based telephony access network and a respective packet-based exchange

(76) Inventors: Norbert Lobig, Darmstadt (DE); Ulrich Preiser, Munchen (DE)

Correspondence Address: Siemens Corporation;Intellectual Property Department, 170 Wood Avenue South, Iselin, NJ, 08830, US

(21) Appl. No.: 10/512,461

(22) PCT Filed: Jun. 11, 2003
(86) PCT No.: PCT/DE03/01938

§ 371 Date: Oct. 22, 2004

(30) Foreign Application Priority Data
Jul. 3, 2002 (DE) 10229900.5

(51) Int. Cl. H04L 12/66

(52) U.S. Cl. 370/352

(57) ABSTRACT

The invention relates to a method for the comfortable and consistent administration of subscriber-specific data and call processing features of a plurality of Multimedia Terminal Adapters of individual cable network telephony subscribers that are connected via one cable modem each to a broadband cable network used as the telephony access network in conjunction with at least one packet-based exchange for providing network and subscriber features, for processing signaling information and controlling the useful data transfer between the subscribers using suitable packet-based protocols. The method is furthermore characterized by a function that, for example, automatically provides a new cable network telephony subscriber with an allocation to a line unit of the exchange. This function also makes it possible for other telephony-relevant data and address positions to be input in a coordinated manner into the broadband cable network and the exchange. The allocation of the port address for the Multimedia Terminal Adapter of a cable network telephony subscriber to a line unit of the exchange can be carried out by the exchange itself, by a superordinate Network Management System and/or in the framework of a preconfiguration by means of at least one planning and configuration tool of the network provider upstream of the Network Management System. The advantages of the inventive system consist mainly in releasing the network provider from any call processing-specific additional addressing of cable network subscribers and in allowing for a decomposition of symbolic addresses during start or restart of the exchange, expired period of validity of the addresses or in the failure mode.

With the technical advance and success of the Internet during recent years, cable modem techniques which allow local cable television networks to be used for transmitting broadband multimedia data have become increasingly important as a low-cost alternative to broadband interactive video services (e.g. video-on-demand, VoD). In this case, the digital multimedia data which is to be transmitted over the cable television network is modulated within the 8 MHz which are normally made available to an analog television channel as a frequency bandwidth on the cable. In this case, the main application areas of these techniques are primarily in broadband access to the Internet or to remote server farms. However, as part of this convergence of time-multiplex-based and packet-based networks, in particular in IP-based (Internet Protocol) networks, adjustments are required on both subscriber side and switching node side.

In the case of telephone access via a broadband cable distribution network, a plurality of network components are relevant. A Network Management System (NMS) and/or a supervisory planning and configuration tool of the network operator supports the packet-based exchanges and the cable access networks. The packet-based exchange (VSt) provides the network facilities and subscriber facilities which are known from conventional switching technology, processes the signaling information and assumes control of the user data transfer between the subscribers using suitable packet-based protocols.

The cable access network consists in each case of a headend and a multiplicity of cable modems which allow the connection of one or more conventional telephone subscribers via Multimedia Terminal Adapters (MTAs). Depending on the technology being used and on the network load, cable modems offer the subscribers between 10 and 47 Mbit/s in downstream mode and between 320 kbit/s and 10 Mbit/s in upstream mode. However, as with every Local Area Network (LAN) which works in conjunction with a shared medium, these figures depend on the number of active stations which share this bandwidth. A cable modem is understood to be an additional external device which is present at the subscriber location and provides a connection interface to a broadband cable distribution network (e.g. the cable television network) on the one side and a LAN connection interface (e.g. Ethernet) on the other side.

The network components intercommunicate via the packet network, wherein configuration information, signaling data and user data are exchanged.

The telephone signaling is exchanged between the Multimedia Terminal Adapters (MTAs) and the exchange (VSt), while the management information is exchanged between the Network Management System (NMS) and the broadband cable distribution network or the exchange.

For reasons of voice quality, the stream of subscriber user data is preferably not carried via the exchange.

In order to allow switching operation, it is necessary to establish the addressability of the subscriber at the MTA by the exchange, and the addressability of the exchange by the MTA. These addressing relationships must be consistently guaranteed when a new MTA or a new subscriber at the MTA is introduced in the broadband cable distribution network or in the exchange. This naturally also applies when an MTA is repaired or replaced, or when failure situations are concluded. The MTA is a device which is present at the subscriber location, said device being either purchased by the subscriber or supplied to the subscriber by the cable network operator, and identifies itself in the broadband cable distribution network by means of its unique and permanent address, namely the Media Access Control (MAC) address. The associated packet address, e.g. an Internet Protocol (IP) address, is temporarily assigned and generally remains unchanged for as long as the MTA is activated in the broadband cable distribution network. The address of the exchange is normally permanent.

From the perspective of the exchange, however, the requirement is not for the MTA to be addressable, but rather the individual port which corresponds to the subscriber terminal at the MTA.

A repair which involves the replacement of an MTA necessarily results in a different MAC address. However, this repair should be possible without operator intervention at the exchange.

This presents the problem of how to effect a consistent assignment of the addressing of ports which are used for switching at the MTA, and of the addressing of these ports in the exchange, such that the cable access network and the exchange do not have to be updated via separate actions. This also applies when setting up a new MTA, adding a subscriber, or making other changes to subscriber data.

The problem therefore consists of assigning a port address or connection interface location to a new cable network telephone subscriber, within the environment of a multiplicity of packet-based exchanges and a further multiplicity of cable networks containing cable network telephone subscribers and a supervisory Network Management System. It must be possible to assign addresses consistently in the cable access network, thus making it convenient to set up a new subscriber or delete a subscriber or make other changes to the subscriber data.

This problem is solved by the method specified in Patent claim 1. Advantageous developments of the invention are specified in the subclaims.

In the above mentioned environment of packet-based exchanges, cable networks containing cable network telephone subscribers and a Network Management System (NMS), the invention provides for a function which, in the case of a new cable network telephone subscriber, automatically establishes an assignment to a port address or connection interface location of the switching system. The individual cable network telephone subscriber is characterized by hardware properties, topological properties and switching properties. When setting up a subscriber, this function extracts a free element from a port address pool which is defined for each exchange, and returns the corresponding port address element to the port address pool when the subscriber is deleted. The port address pool is defined statically and has certain properties, wherein there is a correlation between the size of the port address pool and the equipment of the exchange as well as the switching resources of the exchange.

If a new subscriber is set up at a new MTA, for example, the MAC address, the hardware type of the MTA, the port location at the MTA, the subscriber topology of the switching subscriber type and the switching facilities are entered into the NMS once.

The NMS then determines the telephone profile on the basis of the subscriber data, and loads the associated profile number or even the complete profile together with the MAC address into the cable network. At the same time, the Network Management System assigns the associated packet address of the MTA port to the exchange. This packet address can be a physical address (e.g. an IP address) of the MTA plus a port index, for example, or a symbolic address of MTA and port, wherein the port name can be defined in accordance with a network standard naming convention. The determined packet address is then loaded into the exchange.

If all ports of an MTA are only addressable via a single (physical or symbolic) packet address for switching applications, the invention provides for the aforementioned port to be accessible from the switching system via an index in addition to this address.

If symbolic addresses which conform to Universal Resource Locators (URL) are used, these are decomposed into physical addresses by accessing a Domain Name Server (DNS) in the context of the startup of the exchange or in the context of the administration. The decomposition is optionally repeated in accordance with predetermined validity on the basis of a timed cycle or in the event of error. In order to reduce the loading effort, preconfigured assignment tables can be present in the NMS and in the exchange. Dynamic address conversion tables are generally used, however, and change in the context of subscriber administration.

The address conversion preferably takes place in peripheral parts of the exchange. This has the advantage that the switching functions are processed on the basis of the neutral port addressing of the exchange.

Conversion to the actual packet address only takes place when messages to the MTA are sent, and conversion to the internal addressing of the exchange takes place immediately after a message is received from the MTA.

When replacing a faulty MTA, the MAC address of the MTA also changes. This address must be input to the NMS with reference to the physical or symbolic packet address which is already known to the broadband cable distribution network. If the broadband cable distribution network corresponds to the Packet Cable Specification (a cable television specification which, in addition to IP standards, includes extensions for a broadband transparent transmission of voice data and other time-critical services between connected stations and the headend of the cable access network), the changed MAC address, for example, is entered in the associated DHCP server (Dynamic Host Configuration Protocol) and used in the context of the startup for allocating the MTA packet addresses. The deletion of an MTA or subscriber at the MTA involves the automatic release of the associated port address.

Protocol-assured communication interfaces or even data interfaces are used as interfaces between NMS and broadband cable distribution network and between NMS and VSt.

The advantages of the described method are the freeing of the network operator from the assignment of an exchange-specific additional addressing of cable network telephone subscribers on the broadband cable distribution network, and the optional support of symbolic addressing, e.g. in the possibility of decomposing symbolic addresses again if the exchange is started up or restarted due to a period of validity expiring or in the event of an error. In particular, the network operator is freed from the coordinated input of the telephone-relevant data into the broadband cable distribution network or into the associated exchange. It is further noted that there also exists the possibility of an alternative access of a cable network subscriber to more than one switching system.

This method therefore allows the centralized operation of cable networks and exchanges, including automatic management of the cable network telephone subscriber addresses on the broadband cable network.

Further advantages, features and properties of the present invention are now explained with reference to several preferred exemplary embodiments and with reference to the accompanying drawings.

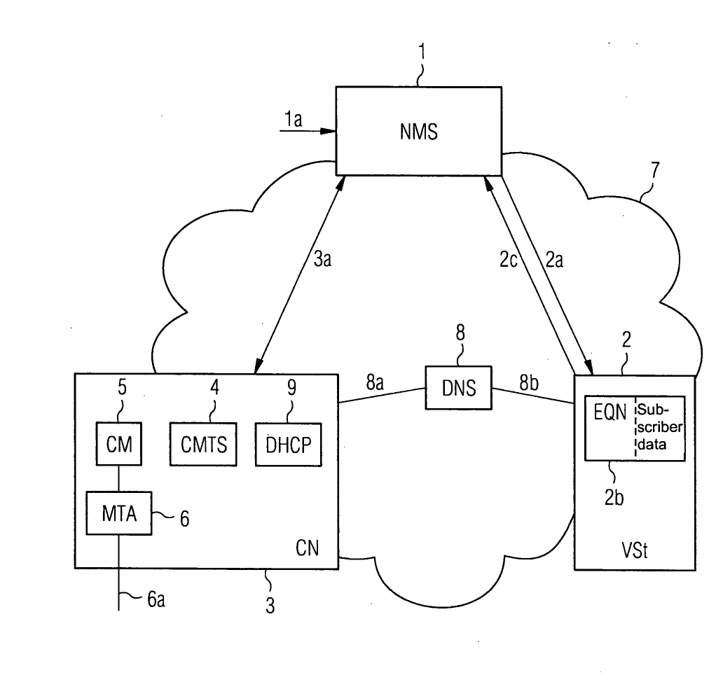

The sole FIGURE (FIG. 1) shows the network design for connecting conventional subscribers via a cable network. The claimed method is illustrated here by way of example in the symbolic address assignment in the Network Management System and the EQN assignment in the exchange.

The example which is illustrated below relates to a so-called “voice-over-cable” project in a broadband cable distribution network 3 which is used in the environment of a packet network 7. In this case, the Network Management System 1 obtains the original input information 1a of the subscriber, including MAC address, terminal adapter type, telephone hardware type, the switching facilities, and the assignment to a cable access network 3 and the assignment to a packet-based exchange 2 on the basis of topological factors or factors which are relevant to the network operator.

The assignment of the symbolic port address 6a at the MTA 6 is done by the Network Management System 1, possibly taking into consideration the input 1a from preceding configuration tools of the network operator.

The switching data, in particular the subscriber type (PSTN or ISDN), facilities and subscriber number circuit, are loaded (2a) from the Network Management System 1 into the switching system or the exchange 2, specifying the symbolic address of the port.

This takes place when introducing new cable network telephone subscribers, for example, but also in the case of administrative changes to the subscriber data.

At the time of loading 2a the subscriber data into the exchange 2, no reference to a device number (Equipment Number, EQN) has yet been created in the switching system. This assignment (2b) is done in accordance with the invention by the exchange 2 itself at the time the cable network subscriber is set up by the Network Management System 1. For this, the exchange 2 uses an EQN management on an equipment number pool which is provided for cable network subscribers in accordance with the invention. The EQN is optionally output (2c) to the Network Management System 1 following specification by the switching system.

The MAC address of the MTA 6 is loaded (3a) from the Network Management System 1 into the broadband cable distribution network 3 with reference to the symbolic address (e.g. MTA3005.CMTSKie15@Netzbetreiber.de) of the MTA and with reference to the telephone profile which is to be used by the MTA. In this context, the telephone profile contains the packet address or possibly addresses of one or more associated packet-based exchanges, together with the parameters which are necessary for the operation of the telephone port 6a, e.g. the definition of the switching tones.

The decomposition of the symbolic addresses of the exchanges, of the MTAs and possibly of the MTA ports into packet addresses is effected by means of at least one Domain Name Server 8 (DNS), which can be accessed by both the broadband cable distribution network 3 and the exchange 2, and which holds the pool of available packet addresses and symbolic name pools of the network (8a, 8b).

Before a new port at an MTA is put into service, the exchange 2 decomposes the symbolic MTA name or possibly the symbolic port name by accessing (8b) the DNS 8. The received packet address remains valid for a predefined time. When the validity expires, a new access (8b) takes place from the exchange 2 to the DNS server 8. The symbolic MTA name or possibly the symbolic port name is part of the subscriber data. The packet address which is assigned via the DNS server 8 is a temporarily valid part of the subscriber data of the switching system. If the MTA has more than one switching port 6a but has only one uniform packet address, and this is normally the case, the port index can be derived from the symbolic name of the port in the exchange in accordance with the naming convention for numbering the ports at the MTA 6a.

In the context of putting the MTA 6 into service, the broadband cable distribution network 3 likewise decomposes the symbolic MTA name by accessing 8a the DNS server 8. The received symbolic address of the MTA is entered in a DHCP (Dynamic Host Configuration Protocol) server 9 of the cable network system and decomposed into the actual packet address by means of DNS access. Said packet address is then available when the MTA 6 is put into service. However, it is likewise only temporarily valid, and is updated after the validity expires by means of a further access from the DHCP server 9 to the DNS server 8.

The assignment of MAC addresses to current packet addresses is therefore available in the DHCP server 9 of the cable network 3. Said DHCP server is polled when the MTA 6 starts up, and makes precisely those packet network addresses which were previously specified by Network Management System 1 and Domain Name System available to the MTA 6.

Partner addresses of at least one exchange 2 are located in the telephone profile which is retrieved by a server of the cable network during the startup of the MTA 6, i.e. after installation or power connection. Again, these can be defined symbolically and decomposed via DNS, or can be fixed physical packet network addresses.

Failure and re-availability of the MTA 6 can occur without intervention at the Network Management System 1. The replacement of an MTA 6 of a subscriber requires the update of the MAC address via the Network Management System 1 and results in the updating of the DHCP server 9. Following the startup of the MTA, telephone services can be provided without further operator intervention at the exchange.

For reasons of simplicity, it is also possible to preconfigure the assignment of exchange-related port addressing in accordance with equipment number (EQN) and addressing by means of packet address and port index or possibly by means of individual packet address available per port. Thus, when peripheral parts of the switching system are put into service, there is already an assignment between the port address which relates to the packet network and the equipment number which is held in exchange 2 and Network Management System 1. It is therefore possible to dispense with the loading of the assignment by the Network Management System 1 in the context of subscriber management on the basis of individual applications, and possibly to dispense with the bulk update of the assignment relationships during initial system startup (e.g. when putting back into service following failure).

1-22. (canceled)

23. A method for managing subscriber data of a subscriber connected via a cable modem to a broadband cable distribution network used as a telephone access network with a packet-based exchange, comprising:
automatically assigning the subscriber to a connection interface location of the exchange;
removing a connection interface location element that is unassigned from a connection interface location pool when the subscriber is set up;
returning the connection interface location element when the subscriber is removed from the network; and
assigning a port address of the subscriber at a multimedia terminal adapter to the connection interface location via a network management system, or specified by the port address via a preconfiguration by a planning and configuration tool of a network operator.

24. The method as claimed in claim 23, wherein a fixed address that identifies the multimedia terminal adapter and a data set are entered into the network management system.

25. The method as claimed in claim 24, wherein the data set describes the subscriber.

26. The method as claimed in claim 25, wherein the data set includes the connection interface location.

27. The method as claimed in claim 23, wherein the network management system specifies a cable modem terminal system and the exchange.

28. The method as claimed in claim 23, wherein the network management system assigns a telephone profile and generates a subscriber packet address information from a location of the connection interface at the multimedia terminal adapter and a fixed address of the multimedia terminal adapter.

29. The method as claimed in claim 28, wherein a physical packet address is allocated to each port of each multimedia terminal adapter as the subscriber packet address information.

30. The method as claimed in claim 28, wherein a physical packet address assigned to the multimedia terminal adapter and supplemented by a port index which is used for a subscriber-specific signaling is allocated to each port of the multimedia terminal adapter as the subscriber packet address information.

31. The method as claimed in claim 28, wherein an individual symbolic address in a packet network is allocated to each port of each multimedia terminal adapter as the subscriber packet address information.

32. The method as claimed in claim 31, wherein the individual symbolic address is selected in accordance with a standard naming convention and references a symbolic name of the multimedia terminal adapter and a port index.

33. The method as claimed in claim 32, wherein the network management system loads the subscriber data into the exchange.

34. The method as claimed in claim 33, wherein the subscriber data includes a subscriber port address.

35. The method as claimed in claim 33, wherein the subscriber data is loaded using the connection interface location.

36. The method as claimed in claim 33, wherein the subscriber data is loaded using a subscriber port address.

37. The method as claimed in claim 33, wherein the exchange includes a preconfigured table for converting the connection interface location and the port address.

38. The method as claimed in claim 23, wherein subscriber-relevant information is available to the broadband cable network via the network management system.

39. The method as claimed in claim 38, wherein the subscriber-relevant information includes a telephone profile of the subscriber, the connection interface location of the subscriber at the multimedia terminal adapter, a fixed address which identifies the multimedia terminal adapter, and a packet address of the subscriber and of the exchanges.

40. The method as claimed in claim 39, wherein the packet address is selected from the group consisting of physical address and symbolic address.

41. The method as claimed in claim 40, wherein during the startup of the exchange, administration, or when putting the multimedia terminal adapter into service, the symbolic address are decomposed into the physical addresses via a DNS server.

42. The method as claimed in claim 23, wherein the address conversion of a signaling data packet within the exchange takes place in a peripheral part of the exchange that is oriented toward the subscribers.

43. The method as claimed in claim 23, wherein when replacing the multimedia terminal adapter, only a new terminal adapter address is specified to the network management system with reference to a previously associated packet address.

44. The method as claimed in claim 23, wherein a plurality of internet protocol addresses are used as the packet addresses of the multimedia terminal adapters and their ports and the exchange.

45. The method as claimed in claim 23, wherein a protocol-assured communication interface or a data interface provides an interface between the network management system, the broadband cable distribution network, and between the network management system and the exchange.

46. The method as claimed in claim 23, wherein the symbolic addresses are decomposed during a startup or restart of the exchange.

47. The method as claimed in claim 23, wherein an alternative access of a cable network subscriber is provided to a plurality of exchanges.

48. An administration system of subscriber data and call processing features, comprising:
a network management system connected to a packet-based exchange and a broadband cable distribution network;
a multimedia terminal adapter included in the broadband cable distribution network;
a subscriber connected via a cable modem to the broadband cable distribution network;
a connection interface location of the exchange which is automatically assigned to the subscriber;
a connection interface location pool including a connection interface location element; the element is removed from the pool when it is assigned to the subscriber, the element is returned to the pool when it is unassigned from the subscriber; and
a port address of the subscriber at the multimedia terminal adapter is assigned to the connection interface location via the network management system.

49. The system as claimed in claim 48, wherein the port address is preconfigured by a planning and configuration tool of a network operator.
